(19) United States
(12) Patent Application Publication
(10) Pub. No.: US 2010/0300541 A1
(43) Pub. Date: Dec. 2, 2010

(54) HVAC branch line, method of making, and method of use

(75) Inventors: Ronald L. Carlay, II, Cookeville, TN (US); Donald Bradley Campbell, Anderson, SC (US); Robert L. Kirby, Sparta, TN (US)

Correspondence Address: CLARK & BRODY, 1700 Diagonal Road, Suite 510, Alexandria, VA, 22314, US

(73) Assignee: Tutco, Inc.

(21) Appl. No.: 12/457,125

(22) Filed: Jun. 2, 2009

(51) Int. Cl. F17D 3/00; B21D 39/00; F16L 11/00

(52) U.S. Cl. 137/1; 29/456; 138/118

(57) ABSTRACT

A HVAC branch line includes a boot, flexible duct, and integral connection therebetween. The boot can be configured to pre-hold fasteners to facilitate field installation. The branch line can also include one or more straps or other another structure, which are used to support the branch line, and optionally compress the duct before, during or after installation. Since the duct and boot are integrally connected, a field connection between the two is unnecessary and the duct can be easily supported during installation of the branch line.

### FIELD OF THE INVENTION

The present invention is directed to a flexible heating, ventilating, and air conditioning (HVAC) branch line, a method for use, and a method of making, and in particular, to a branch line that has an integral boot and duct connection and links a conditioned space to a source duct or plenum.

### BACKGROUND ART

The prior art discloses a number of HVAC boots, registers, boxes, and other components for use in conjunction with ductwork or that are a part of a connectable ductwork system. U.S. Pat. No. 2,935,307 to Goemann teaches the concept of a boot linked to an air source. U.S. Pat. No. 3,225,677 to Steele teaches a junction chamber used for equalizing pressure in an HVAC system incorporating connections for supply and return ducts. U.S. Pat. No. 4,750,411 to Eversole teaches a HVAC boot that is more flexible in that it adapts to receive different conduits. U.S. Pat. No. 5,240,288 to Inda discloses a double air boot that is configured for ease of manufacturability and is used to link an air duct in the floor with the space above the floor. U.S. Pat. No. 7,393,021 to Lukjan teaches a duct boot and method for connecting to a duct. U.S. Pat. No. 5,095,942 to Murphy and U.S. Pat. No. 7,410,416 to Fettkether teach HVAC ductwork systems comprised of conduits, boots, and other components designed either for connectivity with other system components or with commonly-used types of ducting. JP 40 2171543A to Nakamura teaches a piping box construction for connecting two separate ducts while allowing a third, separate duct to pass through the box.

In the prior art, the boots (or other components) that distribute air to a conditioned space are connected to the duct by various means. FIG. 1 is a schematic representation of a typical assembly of components used in an HVAC system. The assembly connects the conditioned space 1 to a source duct or plenum 3, i.e., a trunk line. The assembly includes a duct 5 and a boot, stacked boot, or other fixture (hereinafter “boot”). The boot 7 is normally supported by structure (not shown) in the vicinity of the opening 9 in the conditioned space 1. This support is typically some type of mechanical fastening, e.g., screws, brackets and screws, etc.

The duct 5 and boot 7 are connected in the field, with the boot typically installed first, and then the duct end 11 connected to the boot end 12. The other duct end 13 is linked to the trunk line 3.

The prior art discussed above is representative of the prior art connections described above. In Goemann, the duct and sill box are integral to the building and constructed as a part of the structure. Steele teaches air-tight connections within the chamber for equalizing supply air pressure within an HVAC duct system. Connections of ducts to the chamber are not specifically addressed. The ducts are connected to the boot in Eversole by a collar using interlocking tabs. The ducting system of Murphy provides an annular groove for the attachment of system parts to “other structures like the commonly used flexible plastic duct”. The double air boot in Inda is separated and one half of the boot is used as a riser which is connected to the duct by embedding both the boot and the duct in cement or concrete. Lukjan uses circumferential interlocking tabs or lips to connect the collar to the boot. The collar is connected to the duct using a two-sided adhesive gasket in combination with a zip tie. Fettkether uses raised flanges and coupling collars to secure the various duct components together. The method of connection described in Nakamura is “wound by aluminum tape and fixed”. Each method employed in the prior art relies on a field connection of a duct to a boot (or other component) whether integral to the construction or at the installation of the ducting system.

Standard industry practice for the connection of non-metallic ducts to boots (boots, fixtures, etc.) involves the use of clamps—metallic (pipe clamp or similar) or non-metallic (zip tie)—in conjunction with either duct tape or mastic. Standard practice for the connection of metallic ducts to boots involves the use of screws in conjunction with either duct tape or mastic. The duct tape and/or mastic are used to help seal the connections that are primarily made by the clamps and/or the screws. The prior art in some cases incorporates these standard connection methodologies and in other cases utilizes different methodologies, often seeking to improve upon the standard methods. In all cases, the prior art is similar to industry standard practice in that they require a proper field installation for a successful connection of the duct to other system components.

Typical HVAC duct systems installed using standard installation methods are prone to leakage, particularly at the connections between the duct and other system components such as boots, takeoffs, etc. Most leakage estimates are around 20% (US EPA Energy Star) depending on the duct system used and the quality of the installation. A major contributing factor to the overall duct system leakage is the attachment of the duct branch lines to duct boots (the duct end 11 boot end 12 connection in FIG. 1) that distribute the conditioned air to the designated space. These connections are typically made around the exterior walls in residential construction—either in the attic space or under the floor in the crawl space or basement. In most cases, these field connections must be made in cramped, dark areas that make the connections difficult to perform well. Thus, leakage tends to be prevalent at these connections. Duct connections to the trunk line 3 are typically made in areas less cramped (duct end 13—trunk line 3 connection in FIG. 1). The connection of the boot 7 to the conditioned space (represented as 1 in FIG. 1) is usually made in a manner in which the duct component extends slightly into the conditioned space.

Often, the opening created for the passage for the duct component is oversized relative to the component end, thus creating a gap. This gap is a source for leakage of conditioned air into the unconditioned space or vice versa. Standard industry practice is to leave the gap unsealed or use caulking, expandable foam, or other sealants to close the gap, the latter approaches being very labor intensive and still subject to leakage due to improper installation, degradation of the material over time or the like.

Standard parts used in HVAC duct systems are designed and manufactured by a number of manufacturers. Flexible ducting is manufactured by many companies, some of which also manufacture other duct components and others that manufacture the duct only. Duct boots, stacked boots, and other components are manufactured by still more companies. Other ducting—metal, corrugated metal and duct board construction—are manufactured by many manufacturers as well, including many contractors. The number of manufacturers and designs of these products leads to problems with tolerances when the products are mated in the field. Duct diameters are typically oversized to accommodate the range of manufacturing tolerances of duct components. This often creates a poor fit and makes it more difficult to insure a leak resistant connection between the duct and the boot.

Although some of the prior art, e.g., Lukjan and Fettkether, attempts to address the problems of duct leakage, the dependence on a field-installed or field-connected junction between the duct and the other duct system components creates the opportunity for improper installation and corresponding leakage. Even with proper installation, issues with manufacturing tolerances may lead to leakage at these connections. Most of the prior art does not attempt to address duct leakage. None of the prior art eliminates the prospect of duct leakage at the duct-to-component connections.

This duct leakage is very costly to the consumer in the form of increased energy expense for wasted conditioned air. Obviously, there is environmental cost from wasted resources to generate the extra energy needed to cover the losses. The leakage resulting from current standard duct installation methods, even those incorporating the prior art, results in added cost to the HVAC industry as well. Duct leakage testing is required for most new installations, particularly when a contractor is seeking to meet rating criteria for energy efficiency programs. Leaks must be repaired and/or reworked until a satisfactory leakage rating is obtained. This adds labor and material costs as well as the cost to retest if necessary. Failure of a field-installed connection can often result in expensive call-backs as well, even on systems that are not subject to duct leakage testing.

In light of the problems with branch lines in HVAC systems, a need exists to provide improved branch line designs in order to ease the field installation of ducts and boots and make the HVAC system more energy efficient.

In response to this need, the present invention provides an improved branch line that avoids the leakage problem inherent in prior art systems as well as facilitating the installation of the branch lines in an HVAC system in a much more efficient manner.

### SUMMARY OF THE INVENTION

It is a first object of the invention to provide an improved branch line assembly for HVAC systems.

It is another object of the invention to provide a method of making the improved branch line assembly that produces a one piece branch line assembly that eliminate the typical field connection between a branch line duct and boot.

A further object of the invention is a method of installing a branch line that is vastly improved when using the inventive branch line assembly.

Other objects and advantages will become apparent as a description of the invention proceeds.

In satisfaction of the foregoing objects and advantages of the invention, the invention is an improvement in HVAC systems that employ boots and ducts and require field connections between the two during an HVAC system installation. One embodiment of the invention relates to a factory method of making a plurality of branch lines for installation in an HVAC system. The method comprises providing a plurality of compressible and flexible ducts of given length, each duct having a boot end and a source end, providing a plurality of HVAC boots, each boot having a conditioned space end and a duct end, and integrally connecting the boot end of each flexible duct to the duct end of each boot in a factory setting to form a plurality of branch lines that are leakproof. These factory-assembled branch lines can then be packaged and shipped to the desired location for installation. The factory setting is one wherein the branch line can be mass produced in a highly cost effective manner.

The method can also include the steps of providing a means for attaching the boot to a structure so that the conditioned space end is in communication with a conditioned space when installed and/or providing a means for supporting at least a portion of the duct either prior, during, or after installation of the boot in the structure as part of an HVAC system.

The integral connection further can be a chemical welding bond, an adhesive bond or some other bond, or the combination of a bond and a mechanical connection to integrally connect the boot end and the duct end together. If the bond and mechanical connection is used, it can comprise an adhesive-containing threaded connection on at least the boot end so that the duct end and boot end are threaded and adhesively bonded together.

The attaching means can include a plurality of brackets on the conditioned space end of the boot and at least one fastener held in each bracket. The supporting means can be a box, bag, or one or more straps for supporting at least a portion of the assembly. When employing a bag or box, either can include a removable portion to expose the conditioned space end of the boot for attachment to adjacent structure. The duct can be held in compression by the supporting means prior to its installation to a trunk line at the source end.

The invention also includes an HVAC branch line that comprises the boot with its conditioned space end and its duct end, the flexible duct having its source end and its boot end, and the integral and leakproof connection between the duct end of the boot and the boot end of the duct. The branch line can also include means for attaching the boot to a structure so that the conditioned space end is in communication with a conditioned space when installed and/or means for supporting at least a portion of the duct either prior, during, or after installation of the boot in the structure as part of an HVAC system. The branch line can include the other features noted above in connection with the method of making the assembly.

The invention is also an improvement in a method of supplying a conditioned gas such as heated or cooled air to a location in a structure using a flexible HVAC duct and boot assembly, whereby the inventive branch line is used as the flexible HVAC duct assembly. The boot of the branch line can also include a seal to fill the gap that exists between the conditioned and unconditioned space once the boot is installed. The seal prevents leakage of conditioned gas into the unconditioned space or vice versa.

### BRIEF DESCRIPTION OF THE DRAWINGS

Reference is now made to the drawings of the invention wherein:

FIG. 1 is a schematic perspective view of a prior art duct assembly.

FIG. 2 is a schematic perspective view of one embodiment of the branch line of the invention.

FIG. 3 is a front view of an exemplary boot for use in the invention.

FIG. 4 is a side view of the boot of FIG. 3.

FIG. 5 is a front view of the boot of FIG. 3.

FIG. 6A is an enlarged view of a portion of the boot of FIG. 3.

FIG. 6B is an enlarged view of a portion of the boot of FIG. 3 with a seal capability.

FIG. 7 is a schematic view of one embodiment of the branch line assembly with means for attaching the boot to structure and means for supporting at least a portion of the branch line.

FIG. 8 is a second embodiment of the branch line.

FIG. 9 is a third embodiment of the branch line.

FIG. 10 is a fourth embodiment of the branch line.

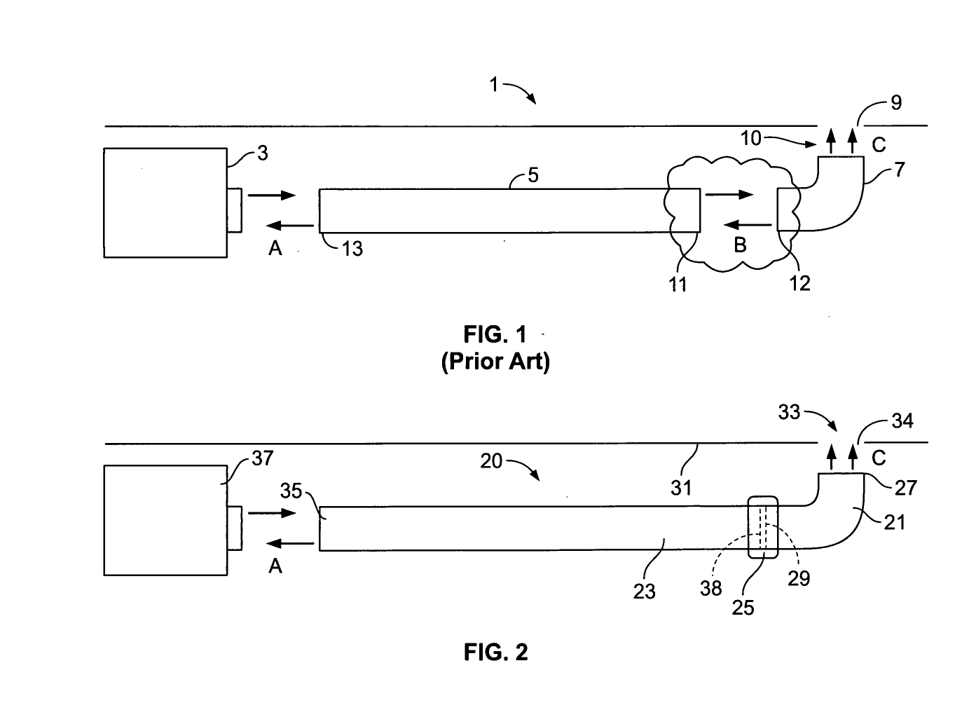

### DESCRIPTION OF THE PREFERRED EMBODIMENTS

The invention offers significant advantages in the field of flexible HVAC ducts. The advantages include the elimination of the field connection normally made when installing a boot and duct in an HVAC system. By eliminating this field connection, the problems with leakage, increased labor costs, size variances between connection ends of the boot and the duct are avoided. The invention provides improved efficiencies in the HVAC system since the integral connection between the boot and the duct is factory made and thus leakproof. The installation is also enhanced when employing the embodiments of the invention including means for attaching the boot to adjacent structure and means for supporting at least the duct for the installation.

Referring to FIG. 2, this embodiment of the invention shows a schematic of the branch line of the invention, which is designated as reference numeral 20. The branch line 20 includes an HVAC boot 21 and a duct 23. An integral connection between the boot 21 and duct 23 is represented by reference numeral 25.

The HVAC boot has a conditioned space end 27 and a duct end 29. The conditioned space end 27 is adapted to attach to a structure, 31 in FIG. 2, so that the end 27 is in communication with a space 33 via opening 34. The space 33 is intended to be serviced by the fluid or gas, e.g., conditioned air or the like, flowing through the assembly 20.

The boot 21 can be any known type of a boot that provides a fluid to a designated space. These boots can have 90 degree orientations as shown in FIG. 2, but can be straight boots, boots employing angles other than 90 degrees, e.g., 45 degrees, multiple-bend boots, and the like. The boot cross section can also take on any shape as well, circular, rectangular, square or other polygonal shapes or a combination of cross sectional shapes.

In another embodiment that is not shown in FIG. 2, the boot also has means on it for attaching it to an adjacent structure such as 31 shown in FIG. 2, e.g., a floor, wall, etc. The attachment means are described in more detail below.

The duct 23 has a source end 35, which is adapted to attach to a trunk line 37 of the fluid being supplied to the space 33, and an end 38 designed to connect to the duct end 29 of the boot 21. This attachment can be any conventional attachment used in HVAC systems. Also, the trunk line 37 represents any conventional source of the fluid for the space 33, e.g., a manifold, header, etc.

While not shown in the embodiment of FIG. 2, the branch line 20 can also means for supporting the duct 23 before, during, or after the installation of the boot to an adjacent structure such as a floor, wall, or the like. Typically, the boot is first installed in an HVAC system, and then the boot is connected to the trunk line at a later point in time. Because the inventive branch line includes the duct and boot due to the integral connection therebetween, it can be important in some instances to be able to support the duct after the boot is installed so that the duct does not become damaged. This supporting means of the branch line assembly allows the boot 21 to be installed at the opening 34 while keeping the duct supported in such a way that it does not interfere with the boot installation or get damaged after the boot is installed. As will be described in more detail below, the means for supporting the duct can include straps or an enclosure that can suspend the duct so that it is not in the way. The straps or enclosure can also be configured to not only suspend the duct but keep it in a compressed state for compactness purposes.

The connection 25 between the boot 21 and duct 23 is an integral type that is factory-made prior to the branch line being shipped to the desired location of use. This factory making means that a number of branch lines can be mass produced and the mass production of the integral connection means that drawbacks associated with making this connection in the field, as is commonly done, are completely eliminated. The types of connections that serve as the means for integrally connecting the duct 23 and boot 21 are disclosed below.

The duct 23 is a flexible type duct so that it can be compressed during the factory making of the connection 25. The duct 23 can be any type of flexible HVAC duct, but is preferably a helical member reinforced thermoplastic duct, the thermoplastic being, for example, polyester, polypropylene, polyvinylchloride, polyethylene, or the like.

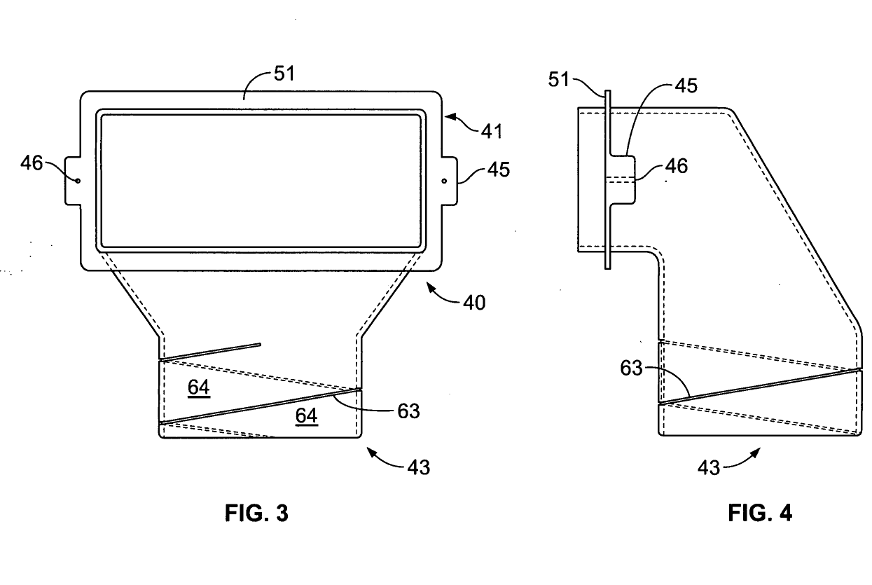

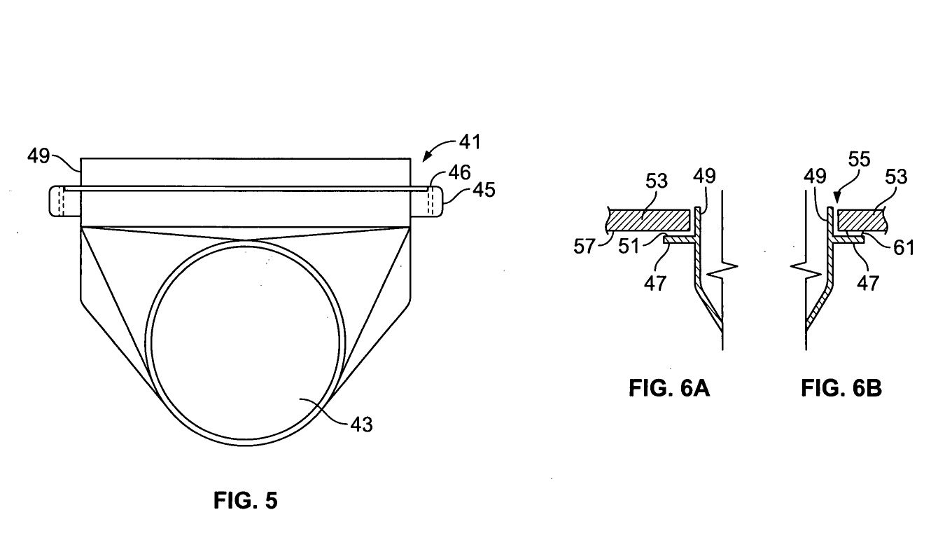

Referring now to FIGS. 3-6, one example of an HVAC boot for use in the invention is illustrated. This boot, designated as 40, has a conditioned space end 41 and a duct end 43. This particular boot has a 90 degree between the plane of the end 41 and plane of the end 43. The boot can be made of any material, but is preferably a polymer material to facilitate the integral connection as detailed below and to ensure the seamless and leakfree passage for the gas.

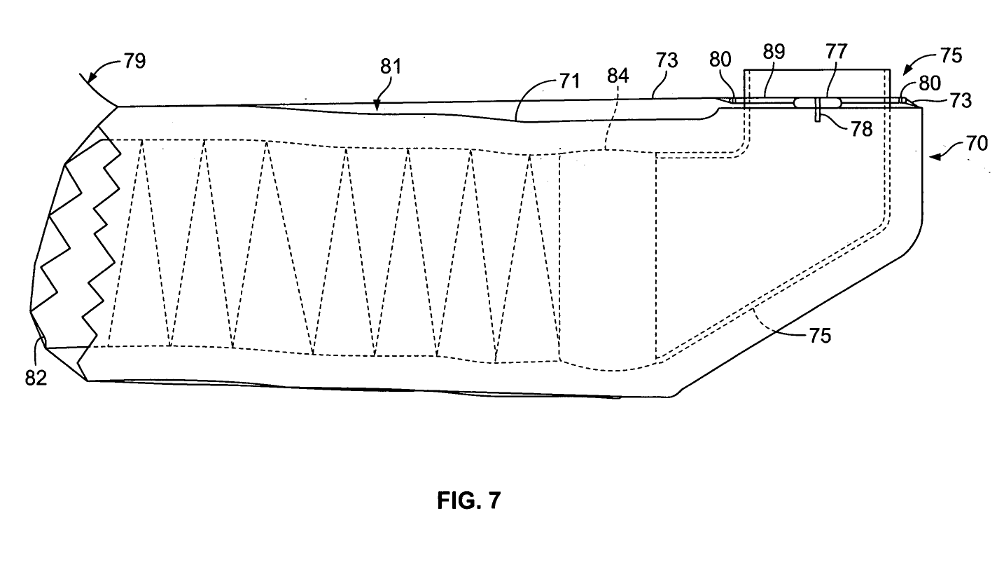

The boot also has structure attaching means in the form of brackets 45. Each bracket has a throughole 46, which allows a fastener to extend through the bracket and attach the boot to adjacent structure. The fasteners, see FIG. 7, are preferably designed so that they are pre-mounted in the througholes 46 so that they are ready to use for installation. This can be accomplished by sizing the throughole 46 slightly smaller than the fastener diameter. The brackets 45 terminate at a flange 47, which completely surrounds the conditioned space end 41. A portion 49 of the boot end 41 extends beyond the flange 47. The portion 49 is designed to extend into the adjacent structure so that the face 51 of the flange 47 contacts an opposing face of the structure.

FIG. 6A shows a detail of the engagement of the end 41 of the boot and a floor 53. The portion 49 is preferably sized so that it terminates at the end of the opening 55 in the floor 53, and permits a register cover or the like to cover the opening 55 as well as the end 41 of the boot 40. The face 51 of the flange contacts the face 57 of the floor 53 once the fasteners (not shown) are attached to the floor 53 using the brackets 45.

In an alternative embodiment in FIG. 6B, the face 51 can include a gasket 61 or seal, whereby the gasket 61 forms a seal between the flange face 51 and the face 57 of the floor 53. The gasket or seal 61 isolates the space being conditioned using the boot 41 from the unconditioned space, e.g., a crawl space, an attic, or similar type environment. This isolation prevents any leakage of unwanted air from the unconditioned space into the space being conditioned using the boot 40. Since conditioned air is usually flowing from boot end 41 into the space, a venturi effect occurs and there is a tendency to draw air through the gap between the floor 53 and the boot 40. The gasket 61 seals this gap, thus improving the efficiency of the HVAC system.

The duct end 43 of the boot 40 is shown with helices or thread 63, which are preferably molded into the boot but can be separate threads that are attached using fasteners or adhesives or the like. These threads interface with the duct end 38 to form the integral connection 25 noted above. In this embodiment, an adhesive is applied between the threads 63 of the end 43, location 44. The end of the boot is threaded onto to a circular duct (not shown), or vice versa, and the connection is heated to integrally link the boot end 41 to the duct 23. This embodiment is especially advantageous when the duct wire has helical member reinforcement. The helical members of the duct interface with the threads 63 on the boot end to produce a strong attachment. Of course, an adhesive could be used that does not require heat to form the bond to make the connection strong and leakproof.

In the threaded connection embodiment described above, the boot is made of a polymer such a polyethylene, polyvinylchloride, or polypropylene and the duct is a polyester type. Since polyester ducts are generally not conducive to chemical welding, adhesives or other bonding techniques, or the combination of adhesives/bonding techniques and mechanical fastening can be employed. However, when the materials of the boot and duct lend themselves to chemical welding, the end of the boot and end of the duct can be integrally connected in the factory operation using chemical welding. While chemical bonding and adhesives are disclosed as examples of using a bond for the integral connection, any bonding techniques that would produce the permanent, irreversible, and leakproof seal of the integral connection can be employed to join the boot and duct into the one piece branch line.

An important aspect of the connection 25 is to ensure that the connection is air tight so that there is no leakage between the duct end 38 and boot end 43 that could compromise the efficiency of the HVAC system. This is an advantage over the prior art techniques since this connection between the duct and the boot is made in the field and is susceptible to leakage due to a number of variables, e.g., difficult to access the location where the connection must be made, installer error, variances in the size of the duct end and boot ends, etc. It should be understood that the adhesive-using integral connection or a chemically welded connection are but two examples of the means for forming an integral connection between the boot end and the duct end. The point of the connection is to form an integral connection that is leakproof and can be mass assembled and then shipped to the desired installation site so that other types of connections could be employed than those disclosed. The integral connection should be strong enough that it will withstand shipping and the installation process without its connection and sealing between the boot and duct being compromised. The integral connection is one that makes the boot and duct virtually a one piece branch line. The integral connection is one that is permanent in its nature and irreversible to the point that undoing the integral connection destroys the functionality of the branch line, i.e., it is no longer useful for its intended purposes. Any undoing of the integral connection also eliminates the leakproof nature of the branch line and defeats this advantage of the invention. By making the branch line in this one piece and leakproof manner in a factory environment, the problems encountered in the prior art in terms of field connections are eliminated.

Referring now to FIG. 7-10, different embodiments of the branch line are illustrated that show the means for supporting the duct of the branch line to ease the installation process. FIG. 7 shows a branch line 70, which is encased in factory-installed insulation 71. A strap 73 is shown attached to the boot 75 via a throughole 80 in the flange 89. This is just one example of an attachment and other ways as would be known in the art can be employed to attach the strap 73 to some part of the boot 75. The manner of mounting the strap 73 to the boot can be any type so long as the strap is securely mounted so that it can be used to support the branch line. The strap 73 also extends along the duct 81 and across the end 82. The strap length can be configured to that its contact with the end 82 of the duct compresses the duct during the installation of the boot and the time before the end 82 is attached to the trunk line. Fasteners 78 are also shown being held at the bracket 77 as part of the means for attaching the boot 75 to adjacent structure.

The strap 73 has a tail 79 extending therefrom. The tail 79 can be attached to a structure such as a floor joist, floor, wall or the like using known means, e.g., fasteners or the like, so that the duct 81 and integral connection 84 are supported before, during, and/or after the installation of the boot 75. While a single flexible strap is disclosed, multiple straps could be employed. Also, while the strap is shown on the exterior of the duct 81, it would also run through the interior of the duct with the strap extending out the end 82 for support purposes. The strap can be free from the insulation 71 and duct 81 in one embodiment. In another embodiment, the strap could be connected to the end 82 to assist in compressing the duct if so desired, with the connection being any conventional type using fasteners, adhesives, or the like.

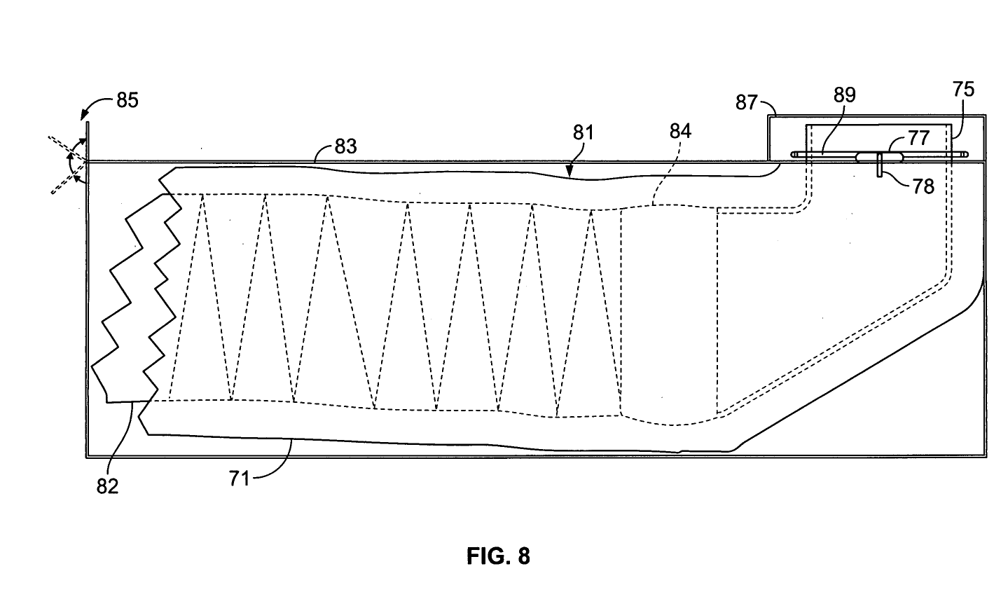

FIG. 8 shows an alternative embodiment, wherein a more rigid container such as a box 83 is used to assist in supporting the duct 81, boot 75, and connection 84. The box 83 can also double as a shipping container as well such that after the assembly is made at the factory, the branch line is put in the box 83 for shipment to the desired installation location. The box is equipped with one or more tabs 85, which function in the same manner as the tail 79 of FIG. 7. The box could be designed to enclose the entire branch line, with portions of the box removed so that the boot 75 could be installed.

An alternative, as shown in FIG. 8, is for the box to have a removable portion 87, which when removed, would expose the portion of the boot 75 necessary for installation to an adjacent structure. With the tab 85 attached to nearby structure, the remainder of the boot 75, connection 84, and duct 81 remain in the box and are supported before, during, and/or after the installation of the boot. In this embodiment, the box 83 is configured so that it still remains connected to the boot so that once the removable portion or cover 87 is removed, the box is stable with respect to the branch line. This could be accomplished by integrating a collar-type feature in the box or the like to surround the boot near the flange 89 or any other structure to maintain a connection between the boot 75 and box 83 once the portion 87 is removed. The box 83 can also be sized so that the duct 81 is compressed during shipment, installation of the boot, and any time prior to connection of the duct 81 to the trunk line.

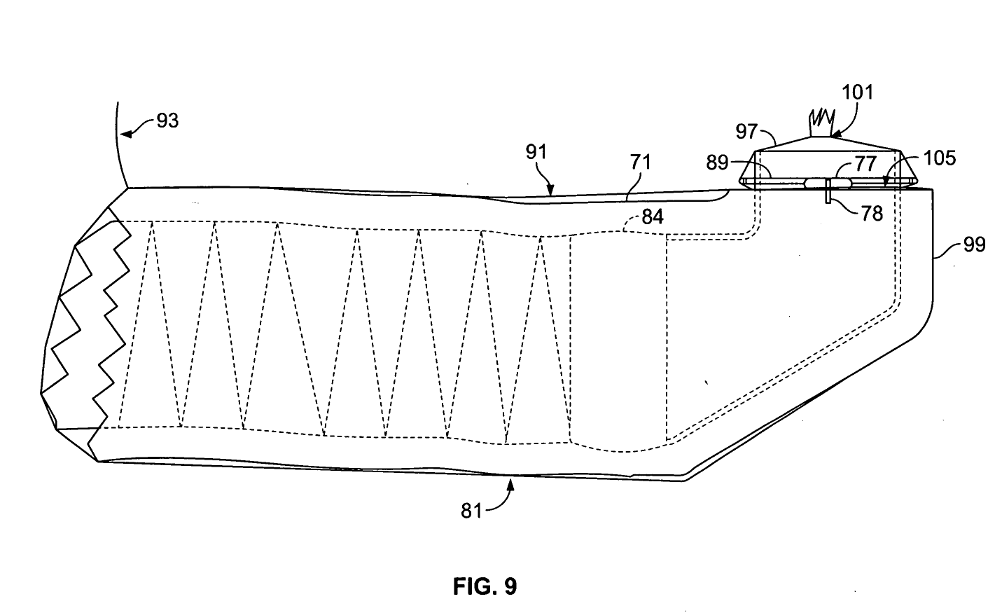

In FIG. 9, a flexible container such as a bag is used in place of the more rigid box of FIG. 8 to assist in supporting the branch line. The bag 91 has one or more portions 93 that functions like the tail 79 of FIG. 7 or the tab 85 of FIG. 8. The portion 93 could be an integral part of the bag 91, e.g., an extruded flap, or a separate flap that would be glued or mechanically attached to the bag 91. A single bag could be used, with a portion removed to expose the boot for installation with another portion still retained to the boot to provide support. A single flap could be employed for support or multiple straps could be used, that would extend along the length of the bag.

The bag 91 could also be designed in more than one part, such that one part, 97 in FIG. 9, would cover the portion of the boot needed for installation, with another part 99 enclosing the remaining parts of the branch line. In this embodiment, the bag part 97 covering the boot end can be removed via perforations or the like between the two bag parts for boot installation and the remaining bag portion remains in place for support of the branch line. In the FIG. 9 embodiment, a tie 101 is employed that keeps the bag portion 97 enclosed about the boot end that involves installation. A second tie 105 keeps the bag attached to the boot for support once the portion 93 is secured in a desired location. Of course, other means could be used to keep the bag portion 99 in place so that it does not become detached from the assembly and compromise the bag's ability to support the branch line prior to connecting the duct to the trunk line. A single tie for restraining an opening of the bag could be used if a bag without a removable portion is employed.

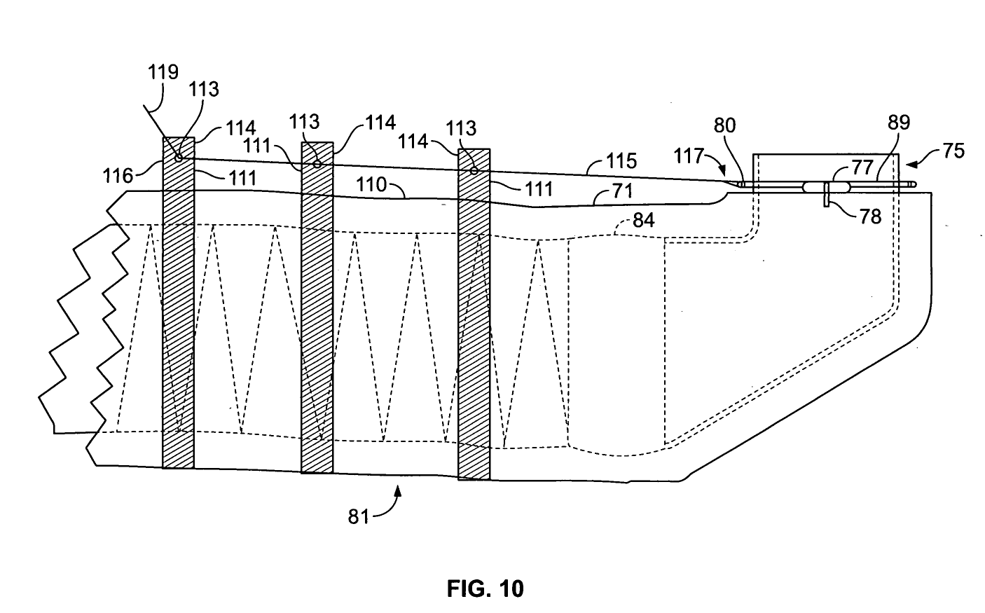

FIG. 10 shows other embodiments of the invention, wherein a plurality of straps 111 are provided. In a first mode as detailed below the straps are unattached. In a second mode, the end strap is attached, and in yet a third mode, all straps are attached.

In the first mode, one end of the straps 111, 116 has an opening 113, which receives a line 115, one end 117 of the line 115 attached to the bracket 77 or the boot 75. The mounting of the line 115 to the bracket 77 or boot 75 can be done in any fashion. The other end 119 of the line 115 is designed to be attached to nearby structure to support the assembly using fasteners and the like just like the tail 79 of FIG. 7. In this mode, the straps 111, 116 are free from the duct 81 so that they can be moved along its length and function as support members when the duct is being connected to the trunk line. Here, the strap ends 114 can be mounted to nearby structure so that the duct is properly supported along its length.

In the second mode, the last strap 116 could be mounted to branch line. With this attachment, the line 115 and its attachment to the end strap 116 can control the compressed length of the duct 81. That is, the line end 119 can be pulled toward the boot 75, which would move the last strap 116 towards the boot. Since the strap 116 is attached to the duct 81, the duct would be compressed accordingly. Leaving some straps 111 free allows the straps to be moved along the length of the duct for later support.

The third mode would have all of the straps 111 and 116 attached to the duct in predetermined locations for support purposes.

If all of the straps 111 and 116 are loose with respect to the duct 81, other means such as a bag, box, or other straps, see FIG. 7, can be employed to keep the duct compressed if compression is desired.

Referring back to FIG. 2, the branch line 20 is made in a factory or other manufacturing facility and then packaged and shipped to the desired site of installation. The factory-making process involves providing a plurality of the flexible ducts 23 as well as a plurality of HVAC boots. A duct and boot are integrally connected at the factory to form the connection 25 using either chemical welding, adhesives and threads on the boot, or some other bonding or bonding/mechanical technique. The boot also is made with a means for attaching the boot to nearby structure, e.g., the tabs shown in FIGS. 3-6, or other configurations that would allow the use of fasteners to secure the boot end in its desired location. The factory operation also includes means for supporting the duct either before, during or after installation, e.g., the use of the box or bag arrangement that the branch line is shipped in, the use of straps designed to both support and compress the duct, or the use of straps alone for the support and compressing capability, see FIGS. 7-10. Once manufactured, the branch lines can then be transported to the field for installation. Of course, the branch line could be made without the boot attaching means and duct supporting means. Then, the boot could be attached in the field with the duct optionally supported if so desired.

A typical installation method would involve at least exposing the end of the boot containing the attaching means so that the boot can be secured to nearby structure and the conditioning space end be aligned with the opening in the nearby structure so that conditioned air or the like can travel through the branch line. Either before, during, or after the installation of the boot end, the remaining part of the branch line can be supported by utilizing the supporting means associated with the branch line. This could entail attaching one or more straps to nearby structure, or attaching one or more flaps/tails/straps from a bag or box enclosing part of the assembly. By first supporting the remaining parts of the branch line, the boot can be easily installed. If the boot is first installed, later supporting of the remaining parts of the branch line eases the attachment of the source end of the duct to the nearby trunk line. If sufficient manpower is available, the branch line supporting means could be utilized while the boot is being mounted for even more efficiency in the installation operation, i.e., using the supporting and attaching means at the same time.

The branch line can be manufactured from any combination of rigid and/or flexible ducting manufactured from any combination of materials—metals, plastics, textiles, fiberglass, etc. The branch line may be manufactured from one piece of material formed into the duct and boot or from multiple pieces of material formed into duct and/or boot and then joined together. The materials used will dictate the method of connecting the branch line together. Regardless of the materials used, the method(s) of connecting the parts of the branch line together is a factory method that produces consistent, leak-resistant connection that is measurable and quantifiable prior to installation.

The branch line may be insulated or non-insulated as required by code and/or contractor. Either version—insulated or non-insulated—will provide the same resistance to leakage as the duct liner and duct components actually convey the air. However, the insulated version offers the advantage of a factory-fitted insulation blanket that covers the entire surface area of the branch line including the component end.

Traditional methods of branch line installation require field-applied insulation which suffers from the same susceptibility to failure as the field-installed connections. This poor-fitting field-applied insulation creates efficiency loss for typical HVAC duct systems. The unitary nature of the branch line requires no disturbance of the accurately-fitted factory insulation during the installation process and, thereby, offers superior thermal efficiency in most cases.

The inventive branch line will not only prevent costly leakage from poor duct-to-component connections, but will save the contractor labor cost on the installation as well. The prior art ways of sealing of duct system connections and components using mastic and/or duct tape is a labor intensive part of the overall duct system installation. The invention reduces the number of field connections in the duct system and eliminates the need to seal the duct components and connections as required in a traditional multi-piece branch line installation. The other features, i.e., the integrated support system, fastener mounts and factory-fitted insulation, further reduce the labor content of the installation by making the branch line easier and faster to install than traditional multi-piece branch lines.

As such, an invention has been disclosed in terms of preferred embodiments thereof which fulfills each and every one of the objects of the present invention as set forth above and provides an HVAC branch line as well as its method of use and making.

Of course, various changes, modifications and alterations from the teachings of the present invention may be contemplated by those skilled in the art without departing from the intended spirit and scope thereof. It is intended that the present invention only be limited by the terms of the appended claims

What is claimed is:

1. A method of making a plurality of branch lines for installation in an HVAC system comprising:
providing a plurality of compressible and flexible ducts of given length, the duct having a boot end and a source end;
providing a plurality of HVAC boots, each boot having a conditioned space end and a duct end; and
integrally connecting the boot end of each flexible duct to the duct end of each boot in a factory setting to form the plurality of branch lines that are leakproof.

2. The method of claim 1 further comprising the step of providing a means for attaching the boot to a structure so that the conditioned space end is in communication with a conditioned space when installed; and/or
providing a means for supporting at least a portion of the duct either prior, during, or after installation of the boot in the structure as part of an HVAC system.

3. The method of claim 1, wherein the integral connection further comprises a chemical welding bond, an adhesive bond, or a combination of a bond and a mechanical connection to integrally connect the boot end and the duct end together.

4. The method of claim 3, wherein the bond and mechanical connection further comprises having an adhesive-containing threaded connection on at least the boot end so that the duct end and boot end are threaded and adhesively bonded together.

5. The method of claim 2, wherein the attaching means further comprises a plurality of brackets on the conditioned space end of the boot and at least one fastener held in each bracket.

6. The method of claim 2, wherein the supporting means further comprises one of a box, bag, or one or more straps for supporting at least a portion of the branch line.

7. The method of claim 6, wherein the bag or box has a removable portion to expose the conditioned space end of the boot for attachment to the structure.

8. The method of claim 2, wherein the duct is held in compression by the supporting means prior to its installation to a trunk line at the source end.

9. An HVAC branched line comprising:
a boot, having a conditioned space end and a duct end, the boot;
a flexible duct having a source end and a boot end; and
an integral connection between the duct end of the boot and the boot end of the duct, the integral connection being leak free.

10. The branch line of claim 9, further comprising means for attaching the boot to a structure so that the conditioned space end is in communication with a conditioned space when installed; and/or
means for supporting at least a portion of the duct either prior, during, or after installation of the boot in the structure as part of an HVAC system.

11. The branch line of claim 9, wherein the integral connection further comprises a chemical welding bond, an adhesive bond, or a combination of a bond and a mechanical connection to integrally connect the boot end and the duct end together.

12. The branch line of claim 11, wherein the bond and mechanical connection further comprises having an adhesive-containing threaded connection on at least the boot end so that the duct end and boot end are threaded and adhesively bonded together.

13. The branch line of claim 9, wherein the attaching means further comprises a plurality of brackets on the conditioned space end of the boot and at least one fastener held in each bracket.

14. The branch line of claim 9, wherein the supporting means further comprises one of a box, bag, or one or more straps for supporting at least a portion of the branch line.

15. The branch line of claim 14, wherein the bag or box has a removable portion to expose the conditioned space end of the boot for attachment to the structure.

16. The branch line of claim 10, wherein the duct is held in compression by the bag, box or at least one strap prior to its installation to a trunk line at the source end.

17. The branch line assembly of claim 10, wherein the boot includes a flange surrounding the conditioned space end, the flange including a seal positioned to fill a gap between the flange and structure receiving the boot, the seal preventing leakage of gas between the conditioned space and an unconditioned space that would be in communication with the conditioned space via the gap.

18. In a method of supplying a conditioned gas to a location in a structure using a flexible HVAC duct and boot assembly, the improvement comprising using the branch line of claim 9 as the flexible HVAC duct assembly.

19. The method of claim 14, wherein the conditioned gas is heater or cooled air.

20. The method of claim 18, wherein the wherein the boot includes a flange surrounding the conditioned space end, the flange including a seal, and wherein the use of the branch line positions the seal between the flange and structure receiving the boot to fill a gap therebetween, the seal preventing leakage of gas between the conditioned space and an unconditioned space that would be in communication with the conditioned space via the gap.
